(19) United States
(12) Patent Application Publication
(10) Pub. No.: US 2010/0311876 A1
(43) Pub. Date: Dec. 9, 2010

(54) LIGNIN ESTER EXTENDED POLYPHENYLENE OXIDE BASED POLYMERS

(75) Inventors: David E. Fish, Bellevue, WA (US); John A. Westland, Auburn, WA (US); Amar N. Neogi, Kenmore, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser NR Company, Federal Way, WA (US)

(21) Appl. No.: 12/479,465

(22) Filed: Jun. 5, 2009

(51) Int. Cl. C08L 97/00

(52) U.S. Cl. 524/73

(57) ABSTRACT

Blends of polyphenylene oxide-based polymers and lignin esters are described. These blends exhibit modulus of elasticity, tensile strength, and elongation at break values that are substantially the same as or greater than the modulus of elasticity, tensile strength, and elongation at break values for the polyphenylene oxide-based polymer alone. The blends provide compositions that have properties comparable to the polyphenylene oxide-based polymers, yet utilize less polymer.

### TECHNICAL FIELD

The present application generally relates to polyphenylene oxide-based polymers blended with lignin esters.

### BACKGROUND

Lignin is found in the cell walls of vascular plants and in the woody stems of hardwoods and softwoods. Along with cellulose and hemicellulose, lignin forms the major components of the cell wall of these vascular plants and woods. Lignin acts as a matrix material that binds the plant polysaccharides, microfibrils, and fibers, thereby imparting strength and rigidity to the plant stem. Lignin also acts as a water sealant in the stems of the plant and plays an important part in controlling water transport through the cell wall. It also protects plants against biological attack by hampering enzyme penetration.

Total lignin content can vary from plant to plant. For example, in hardwoods and softwoods, lignin content can range from about 15% to about 40%. Due to the widespread availability of lignin from manufacturing processes that focus on recovering polysaccharide components of plants, there has been ongoing interest in the utilization of lignin. Wood pulping is one process for recovering lignin and is one of the largest industries in the world. Various types of wood pulping processes exist, including Kraft pulping, sulfite pulping, soda pulping, and organosolv pulping. Each of these processes results in large amounts of lignin being extracted from the wood. Large amounts of the extracted lignin are generally considered to be waste and are either burned to recover energy or otherwise disposed of. Only a small amount of lignin is recovered and processed to make other products. Efforts have been made to utilize the large availability of industrial lignin. Interest in these efforts is motivated by the wide-spread availability of lignin and the renewable nature of its source. In addition, the biodegradability of lignin makes it attractive from a “green” perspective.

One reported use of lignin is as a co-polymer or polymer additive. For example, it has been suggested that lignin may be useful as a filler material in thermoplastic and thermosetting polymers. Efforts have been made to modify lignin so that its compatibility with polymers can be increased. For example, it has been suggested that modification of hydroxyl groups on the lignin molecule could affect the lignin miscibility and thereby improve the chances of plasticization and the resultant lowering of glass transition temperatures and processing temperatures.

It is generally true that when “plasticizers” are added to thermoplastic materials, they cause an increase in elongation at break (maximum strain) and a decrease in stress at break (tensile strength) and in the modulus of elasticity (MOE or Young's modulus). See Handbook of Plasticizers, George Wypich Editor, ChemTec Publishing, 2004, pp. 165-166. There are some plasticizers which are termed “anti-plasticizers”. Even though they also lower the glass transition temperature, usually at low addition rates they have the exact opposite effect on mechanical properties; that is they decrease elongation and increase tensile strength and MOE.

Blends of the biodegradable thermoplastics cellulose acetate butyrate, poly-hydroxy butyrate, poly-hydroxy butyrate-co-valerate, and starch-caprolactone with lignin acetate, lignin butyrate, lignin hexanoate, and lignin laurate have been reported. See Blends of Biodegradable Thermoplastics With Lignin Esters, Indrajit Ghosh and Professor W. Glasser, Masters of Science in Wood Science and Forest Products, Virginia Polytechnic Institute and State University, Apr. 22, 1998. While Ghosh et al. describes that improvements in MOE and tensile strength were observed with certain blends of the noted thermoplastics and the noted lignin esters, there is continued interest in cost-effective materials that when added to thermoplastic polymers behave as plasticizers and reduce the glass transition temperature and a blend that exhibits the same or increased MOE and tensile strength while also exhibiting the same or increased elongation at break compared to the thermoplastic polymer. Such behavior would be unique since it would combine the best attributes of a plasticizer and an anti-plasticizer. Such blends would be useful in applications where the MOE, tensile strength, and elongation at break values of the original thermoplastic polymer were desirable, yet would be more economical on a per weight basis in view of the introduction of a less expensive material.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the embodiments described herein relate to a mixture of a thermoplastic polymer and a lignin ester wherein the thermoplastic polymer is a polyphenylene oxide-based polymer. The mixture contains about 1 to about 40 parts lignin ester per 100 parts polyphenylene oxide-based polymer on a weight basis.

Another aspect of the embodiments described herein relates to a mixture of a thermoplastic polymer and a lignin ester. The thermoplastic polymer is a polyphenylene oxide-based polymer and the lignin ester includes ester groups that contain 2 to 13 carbon atoms. The lignin ester is present in an amount effective to result in a mixture that exhibits a modulus of elasticity that is substantially the same as or greater than the modulus of elasticity of the polyphenylene oxide-based polymer. The mixture exhibits an elongation at break value that is substantially the same as or greater than the elongation at break value of the polyphenylene oxide-based polymer. The tensile strength value for the mixture is at least 100% of the tensile strength value of the polyphenylene oxide-based polymer.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a bar chart illustrating modulus of elasticity values for films comprising poly-2,6-dimethyl-1,4-phenylene oxide alone and films comprising blends of poly-2,6-dimethyl-1,4-phenylene oxide and softwood lignin acetate at softwood lignin acetate loadings of 10 parts, 20 parts, and 30 parts per 100 parts poly-2,6-dimethyl-1,4-phenylene oxide;

FIG. 2 is a bar chart illustrating elongation at break values for films comprising poly-2,6-dimethyl-1,4-phenylene oxide alone and blends of the same with softwood lignin acetate at the same loadings described above with respect to FIG. 1;

FIG. 3 is a bar chart illustrating breaking strength values for poly-2,6-dimethyl-1,4-phenylene oxide alone and films produced from blends of poly-2,6-dimethyl-1,4-phenylene oxide and softwood lignin acetate at the same loading levels described above with regard to FIG. 1;

FIG. 4 is a bar chart illustrating modulus of elasticity values for films comprising poly-2,6-dimethyl-1,4-phenylene oxide alone and films comprising blends of poly-2,6-dimethyl-1,4-phenylene oxide and softwood lignin propionate hexanoate at softwood lignin propionate hexanoate loadings of 5 parts, 10 parts, 20 parts, 30 parts, and 40 parts per 100 parts poly-2,6-dimethyl-1,4-phenylene oxide;

FIG. 5 is a bar chart illustrating elongation at break values for films comprising poly-2,6-dimethyl-1,4-phenylene oxide alone and blends of the same with softwood lignin propionate hexanoate at the same loadings described above with respect to FIG. 4;

FIG. 6 is a bar chart illustrating breaking (tensile) strength values for poly-2,6-dimethyl-1,4-phenylene oxide alone and films produced from blends of poly-2,6-dimethyl-1,4-phenylene oxide and softwood lignin propionate hexanoate at the same loading levels described above with regard to FIG. 4; and

FIG. 7 is a graph illustrating glass transition temperatures for poly-2,6-dimethyl-1,4-phenylene oxide and softwood lignin propionate hexanoate at the same loading levels described above with regard to FIG. 4 but expressed as a weight fraction.

### DETAILED DESCRIPTION

The mixture of thermoplastic polymer and a lignin ester of the embodiments described herein includes a polyphenylene oxide-based polymer and a lignin ester. Films formed from the mixture exhibit modulus of elasticity values that are substantially the same as and preferably no less than the modulus of elasticity values for films formed from the polyphenylene oxide-based polymer alone. In addition, films formed from the mixture exhibit breaking strength (tensile strength) and elongation at break values that are substantially the same as and preferably no less than the breaking strength (tensile strength) and elongation at break values for films formed from the polyphenylene oxide-based polymer alone. Details regarding polyphenylene oxide-based polymers and lignin esters making up the mixtures of the embodiments disclosed herein are provided in more detail below. The following description makes reference to the specific polyphenylene oxide-based polymer poly-2,6-dimethyl-1,4-phenylene oxide and the specific lignin esters, lignin acetate, and lignin propionate hexanoate; however, it should be understood that the claimed subject matter is not necessarily limited to these specific materials.

Polyphenylene oxide-based polymers of the embodiments described herein are generally represented by the formula:

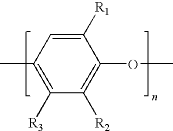

In the above formula, at least one of R₁ and R₂ is a halogen atom, a hydrocarbon group, a halogen- or cyano-substituted hydrocarbon group, a hydrocarbon-oxy group, or a halogen-substituted hydrocarbonoxy group, and the other is a hydrogen atom. Further, R₃ is any of the substituents represented by R₁ and R₂ and n is a polymerization degree represented by an integer of 50 or more. Examples of R₁, R₂, and R₃ are hydrogen, chlorine, bromine, iodine, methyl, ethyl, propyl, allyl, phenyl, tolyl, benzyl, methylbenzyl, chloromethyl, bromomethyl, cyanoethyl, methoxy, ethoxyl, phenoxy, chloromethoxy, and the like.

Specific examples of polyphenylene oxide-based polymers useful in the embodiments described herein include:

poly-2,6-diethyl-1,4-phenylene oxide;

poly-2,6-dimethyl-1,4-phenylene oxide;

poly-2,6-dipropyl-1,4-phenylene oxide;

poly-2-methyl-6-isopropyl-1,4-phenylene oxide;

poly-2,6-dimethoxy-1,4-phenylene oxide;

poly-2,6-dichloromethyl-1,4-phenylene oxide;

poly-2,6-diphenyl-1,4-phenylene oxide; and

poly-2,6-dichloro-1,4-phenylene oxide.

Another example of a polyphenylene oxide-based polymer useful in embodiments described herein that is not represented by the formula above is poly-2,5-dimethyl-1,4-phenylene oxide.

The following description makes reference to the specific polyphenylene oxide-based polymer poly-2,6-dimethyl-1,4-phenylene oxide; however, it should be understood that the claimed subject matter is not necessarily limited to this particular polyphenylene oxide-based polymer.

In addition, the polyphenylene oxide-based polymers can take the form of blends with polystyrene and styrene butadiene, provided the polyphenylene oxide-based polymer forms greater than 40% of the blend on a weight basis.

Furthermore, polyphenylene oxide-based polymers include copolymers obtained, for example, by co-polymerization, graft polymerization, block polymerization, and other methods of incorporating additional materials into the polyphenylene oxide polymer molecule and where the fraction of polyphenylene oxide as measured on a monomeric basis is greater than 40%. One example of a copolymer that includes a polyphenylene oxide based polymer is a graft polymer of polyphenylene oxide and polycaprolactam (Nylon 6).

In preferred embodiments, polyphenylene oxide-based polymers useful in the embodiments described herein are further characterized by the inclusion of a phenyl group in the polymer backbone and not as a pendant group such as occurs with polystyrene. Polyphenylene oxide-based polymers useful in the embodiments described herein are amorphous materials, having a crystallinity that is less than the crystallinity of polymers such as polyhydroxy butyrate. Unlike polycarbonate polymers, preferred polyphenylene oxide-based polymers do not include carbonate groups.

Lignin esters are derived from lignin derivatives originating from lignocellulosic biomass. Hardwood and softwood trees are examples of sources of lignin derivatives from which lignin esters useful in the embodiments described herein are derived. Energy crops such as switchgrass, miscanthum, prairie cordgrass, and native reed canary grass are other examples of sources of lignin derivatives that are useful to produce lignin esters useful in the embodiments described herein. Other sources of lignin derivatives include tobacco, corn stovers, corn residues, corn husks, sugar cane bagasse, castor oil plant, rapeseed plant, soybean plant, cereal straw, grain processing by-products, bamboo, bamboo pulp, bamboo sawdust, rice straw, paper sludge, waste papers, recycled papers, and recycled pulp.

Lignin derivatives are obtained from lignocellulosic biomass using processes designed to separate lignin from the polysaccharide components of the biomass. For hardwoods and softwoods, such processes include the Kraft, organosolv, steam explosion, acid hydrolysis, hydrolytic, soda, enzymatic, and sulfite extraction processes. Lignin derivatives from other lignocellulosic biomass materials such as energy crops can be obtained by processes such as mild acid extraction, organosolv, steam explosion, and ball milling. The molecular weight of lignin derivatives suitable for use in preparing lignin esters useful in the embodiments described herein can vary over a wide range. In specific embodiments described herein, the lignin derivatives have molecular weights ranging from 3000 to 9000 Daltons.

Lignin esters used to form mixtures of the embodiments described herein are produced by reacting a lignin derivative with esterifying agents, such as carboxylic acids or their anhydrides, to produce lignin esters. Further description of methods for producing lignin esters from lignin derivatives are provided in Example 1. Preferred lignin esters for use in the embodiments described herein are fully esterified. By fully esterified, it is meant that all the hydroxyl groups of the lignin derivative have been converted to ester groups.

An exemplary structure for lignin esters useful in the embodiments described herein is represented by the following formula:

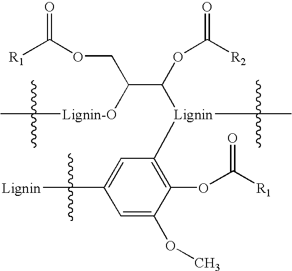

wherein R₁ is any hydrocarbon containing up to 12 carbon atoms and R₂ is any hydrocarbon containing up to 12 carbon atoms. Specific examples of R₁ and R₂ substituents include methyl, ethyl, propyl, butyl, pentyl, hexyl, heptyl, octyl, nonyl, decyl, undecyl, dodecyl and phenyl groups. In one preferred embodiment, R₁ is C₁ to C₅ alkyl and R₂ is C₁ to C₅ alkyl. In one more preferred embodiment, R₁ is C₁ alkyl and R₂ is C₁ alkyl. In another preferred embodiment, R₁ is C₂ alkyl and R₂ is C₅ alkyl. Alkyl as used herein refers to a univalent radical consisting of carbon and hydrogen atoms arranged in a chain. Alkyl groups are derived from members of the alkane series. R₁ and R₂ may also be branched hydrocarbons such as iso-butane, iso-pentane and iso-hexane. R₁ and R₂ may also be cyclic, hydrocarbons, such as cyclopropane, cyclobutane and cyclopentane.

In accordance with embodiments described herein, when lignin esters are mixed with polyphenylene oxide-based polymers, in an amount ranging from about 1 to less than 40 parts lignin ester per 100 parts polyphenylene oxide-based polymer the modulus of elasticity values for films produced from the mixture are substantially the same, and preferably at least the same as or greater than the modulus of elasticity values for films of the polyphenylene oxide-based polymer alone. In addition, tensile strength and elongation at break values for films produced from the mixture are substantially the same as, and preferably at least the same as or greater than the tensile strength and elongation at break values for films of the polyphenylene oxide-based polymer alone.

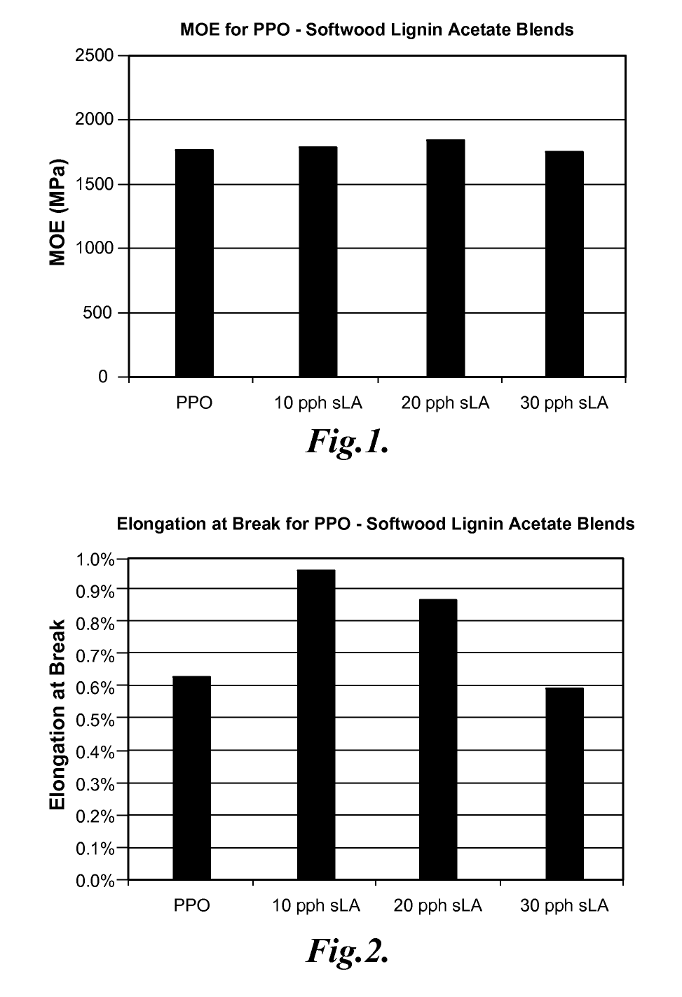

FIG. 1 is a graphical representation of modulus of elasticity values measured using dynamic mechanical analysis. FIG. 1 shows that modulus of elasticity values for films formed from blends of the polyphenylene oxide-based polymer poly-2,6-dimethyl-1,4-phenylene oxide with 10 parts, 20 parts, and 30 parts softwood lignin acetate per 100 parts poly-2,6-dimethyl-1,4-phenylene oxide are substantially the same (within 14 MPa) or greater than modulus of elasticity values for films formed from poly-2,6-dimethyl-1,4-phenylene oxide polymer alone. Further details regarding the modulus of elasticity values presented in FIG. 1 are provided below in the examples.

FIG. 2 is a graphical representation of elongation at break values for films formed from the same blends of poly-2,6-dimethyl-1,4-phenylene oxide and softwood lignin acetate for which modulus of elasticity values are represented in FIG. 1. FIG. 2 shows that elongation at break values for films formed from the blends is substantially the same (within 0.04%) or is greater than the elongation at break value for films of poly-2,6-dimethyl-1,4-phenylene oxide alone. Further details regarding the elongation at break values represented in FIG. 2 are provided in the examples.

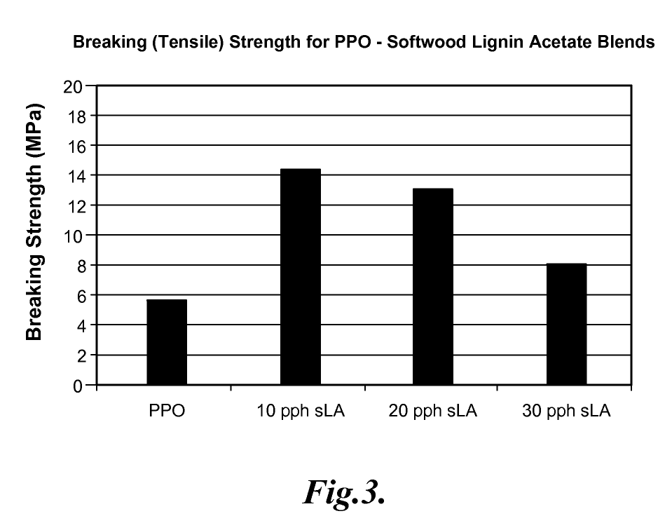

FIG. 3 is a graphical representation of breaking strength or tensile strength values for films formed from the same blends of poly-2,6-dimethyl-1,4-phenylene oxide and softwood lignin acetate for which modulus of elasticity values are represented in FIG. 1. FIG. 3 shows that the films formed from the blends exhibit tensile strength values that are equal to or greater than the tensile strength value for films formed from the poly-2,6-dimethyl-1,4-phenylene oxide polymer alone. Further details regarding the tensile strength values presented in FIG. 3 are provided in the examples.

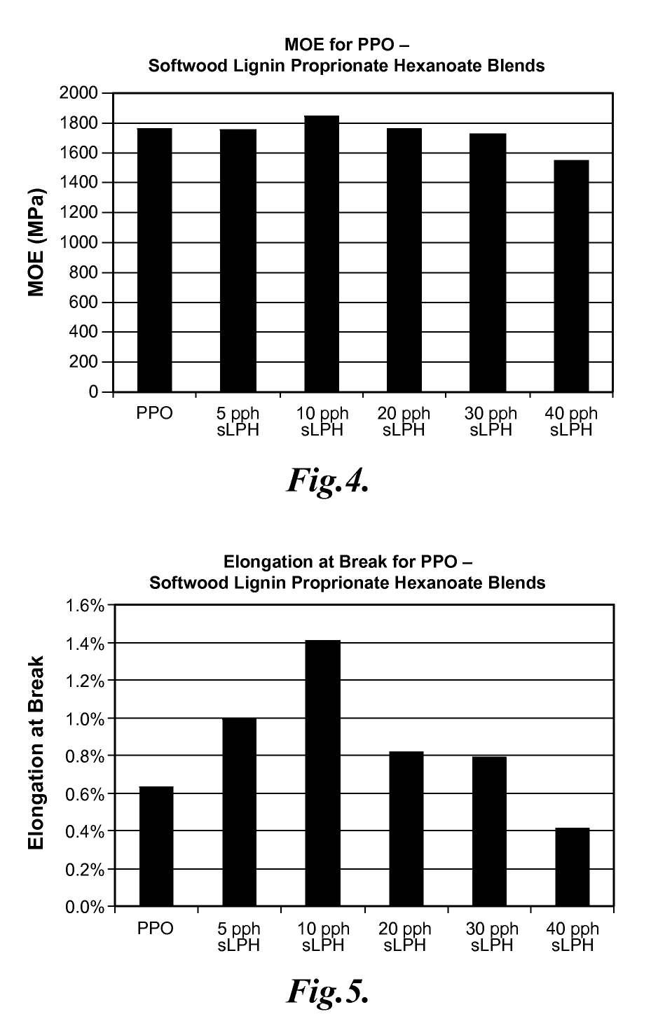

FIG. 4 is a graphical representation of modulus of elasticity values measured using dynamic mechanical analysis. FIG. 4 shows that modulus of elasticity values for films formed from blends of the polyphenylene oxide-based polymer poly-2,6-dimethyl-1,4-phenylene oxide with 5 parts, 10 parts, 20 parts, and 30 parts softwood lignin propionate hexanoate per 100 parts poly-2,6-dimethyl-1,4-phenylene oxide are substantially the same (within 14 MPa) or greater than modulus of elasticity values for films formed from poly-2,6-dimethyl-1,4-phenylene oxide polymer alone. FIG. 4 also shows modulus of elasticity values for films formed from a blend of the polyphenylene oxide-based polymer poly-2,6-dimethyl-1,4-phenylene oxide with 40 parts softwood lignin propionate hexanoate per 100 parts poly-2,6-dimethyl-1,4-phenylene oxide is 216 MPa less than the modulus of elasticity value for films formed from poly-2,6-dimethyl-1,4-phenylene oxide alone. Further details regarding the modulus of elasticity values presented in FIG. 4 are provided below in the examples.

FIG. 5 is a graphical representation of elongation at break values for films formed from the same blends of poly-2,6-dimethyl-1,4-phenylene oxide and softwood lignin propionate hexanoate for which modulus of elasticity values are represented in FIG. 4. FIG. 5 shows that elongation at break values for films formed from blends having softwood lignin propionate hexanoate loadings of 5 parts, 10 parts, 20 parts, and 30 parts per 100 parts poly-2,6-dimethyl-1,4-phenylene oxide are greater than the elongation of break values for films of poly-2,6-dimethyl-1,4-phenylene oxide alone. FIG. 5 shows that the elongation at break value for films formed from a blend of 40 parts softwood lignin propionate hexanoate per 100 parts poly-2,6-dimethyl-1,4-phenylene oxide is 0.22% less than the elongation at break value for films formed from poly-2,6-dimethyl-1,4-phenylene oxide alone. Further details regarding the elongation at break values represented in FIG. 5 are provided in the examples.

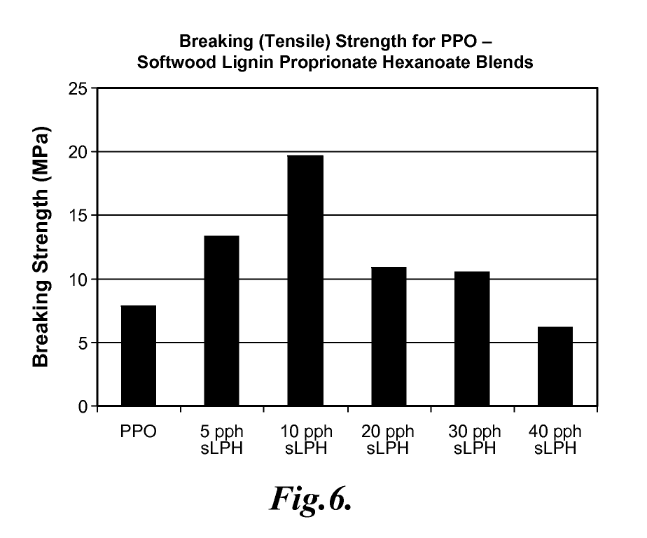

FIG. 6 is a graphical representation of breaking strength or tensile strength values for films formed from the same blends of poly-2,6-dimethyl-1,4-phenylene oxide and softwood lignin propionate hexanoate for which modulus of elasticity values are represented in FIG. 4. FIG. 6 shows that tensile strength values for films formed from blends containing 5 parts, 10 parts, 20 parts, and 30 parts lignin propionate hexanoate per 100 parts poly-2,6-dimethyl-1,4-phenylene oxide are greater than the tensile strength value for films formed from the poly-2,6-dimethyl-1,4-phenylene oxide polymer alone. Films formed from a blend containing 40 parts lignin propionate hexanoate per 100 parts poly-2,6-dimethyl-1,4-phenylene oxide exhibit a tensile strength that are 1.7 MPa less than the tensile strength value for films formed from the poly-2,6-dimethyl-1,4-phenylene oxide polymer alone. Further details regarding the tensile strength values presented in FIG. 6 are provided in the values.

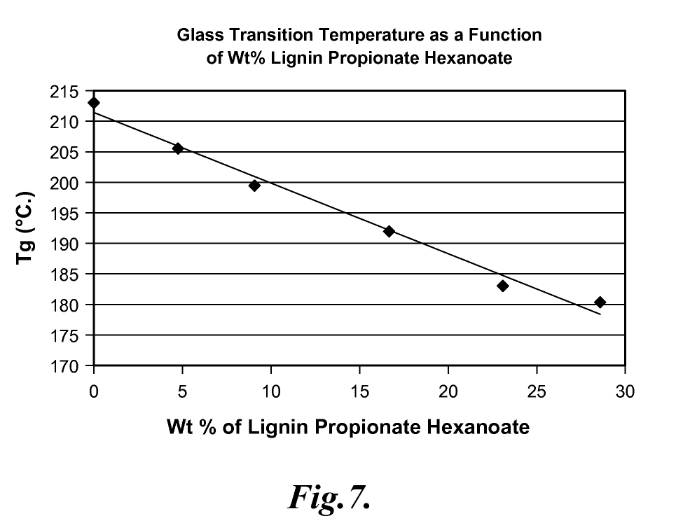

FIG. 7 is a graphical representation of the glass transition temperatures as measured on a differential scanning calorimeter for films formed from the same blends of poly-2,6-dimethyl-1,4-phenylene oxide and softwood lignin propionate hexanoate for which modulus of elasticity values are represented in FIG. 4. The levels of the softwood lignin propionate hexanoate are expressed in terms of weight percent of softwood lignin propionate hexanoate—that is grams of the lignin ester per 100 grams of the mixture. There is a near perfect linear trend indicating complete miscibility at least up to 40 pph or the equivalent 28.57% on a weight basis.

It is contemplated that when less than 1 part lignin ester is added to 100 parts polyphenylene oxide-based polymer, the modulus of elasticity, tensile strength, and elongation at break values of the mixture would continue to be at least substantially the same as or greater than the modulus of elasticity, tensile strength, and elongation at break values for the polyphenylene oxide-based polymer alone. A preferred amount of lignin ester present in the mixture ranges from about 1 part to about 30 parts lignin ester per 100 parts polyphenylene oxide-based polymer. A more preferred amount of lignin ester ranges from about 5 parts to about 30 parts lignin ester per 100 parts polyphenylene oxide-based polymer. These latter two ranges of lignin ester are preferred because they result in a mixture exhibiting modulus of elasticity and elongation at break values that are substantially the same as or greater than the modulus of elasticity and elongation at break values of the polyphenylene oxide-based polymer alone, and tensile strength values that are greater than the tensile strength values for the polyphenylene oxide-based polymer alone.

The polyphenylene oxide-based polymers and lignin esters can be blended using conventional techniques that produce a miscible blend of the two components. If necessary, suitable solvents such as chloroform can be employed. A description of one specific method for forming a blend of polyphenylene oxide-based polymers and lignin esters is provided in Example 4 below.

### EXAMPLES

### 1. Lignin Acetate Preparation

Lignin acetate (LA) was produced as follows:

1.499 kg n-methylpyrrolidinone was added to 3 liter resin kettle. The resin kettle was placed in a room temperature water bath and stirred under ambient conditions while gradually adding 500.9 g of spruce softwood Kraft lignin until complete dissolution was achieved. The final lignin concentration was 25.05 weight percent. 25 mL (d=1.031 g/mL, 25.775 g) 1-methylimidazole (5.15 weight percent of lignin) was added to the solution, mixing 5 minutes to incorporate. 400 mL acetic anhydride (1.081 g/mL, 102.09 g/mol, 4.235 moles) was added dropwise over 1 hour to the resin kettle via an addition funnel. Once addition was complete, the reaction continued with stirring at room temperature for an additional 4 hours. The product was recovered by precipitating the product through addition of an equal volume of DI water. The resulting lignin acetate was washed multiple times with DI water to remove residual solvent and reactants. It was then dried and dissolved in CHCl₃ before washing three times with a 0.5 M solution of sodium bicarbonate followed by one wash with DI water. The organic layer was dried with magnesium sulfate which was filtered off before evaporating the chloroform layer.

### 2. Lignin Propionate Hexanoate Preparation

Lignin propionate hexanoate (LPH) was produced as follows:

49.98 g of spruce softwood Kraft lignin was added to a 250 mL round bottom flask that was charged with 199.94 g n-methylpyrrolidinone to give a final lignin concentration of 19.98 weight percent. A water condenser was attached to one port and the flask was placed in a room temperature water bath and stirred under ambient conditions until the lignin had completely dissolved. 10.35 g 1-methylimidazole (20.71 weight percent of lignin) was added to solution, mixing 5 minutes to incorporate. 37.81 g propionic anhydride (130.14 g/mol, 0.2905 moles) and 54.24 g hexanoic anhydride (214.3 g/mol, 0.2531 moles) were mixed together and added dropwise over 30 minutes to the flask via an addition funnel. Once addition was complete, the reaction continued with stirring at room temperature for an additional 2 hours. The product was recovered by precipitating the solution into 500 mL DI water. The resulting lignin propionate hexanoate was washed multiple times with DI water to remove residual solvent and reactants. It was then dissolved in CHCl₃ before washing two times with a 0.5 M solution of sodium bicarbonate followed by two washes with DI water. The organic layer was dried with magnesium sulfate that was filtered off before evaporating the chloroform layer.

### 3. Film Preparation

An appropriate amount of poly-2,6-dimethyl-1,4-phenylene oxide (PPO) available from Sigma-Aldrich, product number 181-781, lignin ester, and solvent were mixed in a small glass vial and then stirred with a magnetic stirrer until all the resin was dissolved. The amounts of resin and lignin ester were calculated to give the desired ratios, a solids percentage of 20-25%, and a solvent volume of 5-10 ml. The exact solids percentage and solvent volume were adjusted to give a level of viscosity which permitted the solution to be poured out of the vial and spread conveniently into a film. The solvent used was chloroform. A PGT bar applicator with a cut depth of 0.003 inches and an overall length of 7.5 inches manufactured by Paul N. Gardner, Inc. was used to produce the films with a width of 6 inches. A 12 inch×12 inch glass plate was used as film forming surface. Both the glass plate and bar were cleaned with chloroform. Clean compressed air was used to blow any remaining lint or dust off the bar and plate. The bar was placed near the top of the plate, and about 5 ml of the polymer solution was evenly laid in a bead just in front of the bar. The bar was then immediately slid down the plate to produce a uniform film. The film was allowed to air dry on the glass for about 4-6 hours. In this manner, transparent films were produced exhibiting no crystalline areas. The films were then carefully separated from the glass plate using a razor blade and water to help free the film. Each film was then dried by heating for 1 hour at 40° C. followed by 4 hours at 75° C. The glass transition temperature (T_{g}) of each film was measured by standard differential scanning calorimetry. Two cycles were run sequentially to see if any remaining solvent was present in the film. That is, if the T_{g} increased between the first and second cycle, there was residual solvent in the film. In this case, the individual film was then heated further until no change in the T_{g} from the first to the second cycle.

### 4. DMA Testing

A model Q800 dynamic mechanical analyzer (DMA) manufactured by TA Instruments of New Castle, Del., was used for all testing. The analyzer was fitted with a tension film clamp, also supplied by TA Instruments, and run in the instrument's controlled force mode. Five to seven samples on the order of 20.7 mm in length and 9.6 mm in width were cut from each test film. The samples ranged in thickness from about 0.024-0.038 mm. After placement in the clamp, an initial static force of 0.0005 N was applied and the temperature of the system was brought to 28° C. After an isothermal resting time of 1 minute, the force was ramped at a speed of 0.3000 N/min. until breakage. Using the supplier's software, modulus of elasticity, elongation at break, and stress at break (tensile strength) were recorded. The results for films containing 10 parts, 20 parts, and 30 parts lignin acetate per 100 parts poly-2,6-dimethyl-1,4-phenylene oxide are summarized in Table 1 below and depicted graphically in FIGS. 1-3. The results for films containing 5 parts, 10 parts, 20 parts, 30 parts, and 40 parts lignin propionate hexanoate per 100 parts poly-2,6-dimethyl-1,4-phenylene oxide are summarized in Table 2 below and depicted graphically in FIGS. 4-6.

TABLE 1

| | MOE | | TS |
|---|---|---|---|
| Sample | (MPa) | EAB | (mPa) |
| PPO | 1762 | 0.80% | 8.9 |
| PPO | 1413 | 0.69% | 8.8 |
| PPO | 1401 | 0.81% | 8.9 |
| PPO | 1895 | 0.46% | 6.2 |
| PPO | 2073 | 0.51% | 5.0 |
| PPO | 1763 | 0.64% | 9.6 |
| PPO | 2029 | 0.50% | 8.0 |
| Ave | 1762 | 0.63% | 7.9 |
| SD | 270 | 0.14% | 1.7 |
| 10 pph LA-PPO | 1517 | 0.75% | 11.1 |
| 10 pph LA-PPO | 1693 | 0.97% | 11.6 |
| 10 pph LA-PPO | 1801 | 0.70% | 10.0 |
| 10 pph LA-PPO | 1647 | 1.19% | 19.0 |
| 10 pph LA-PPO | 1788 | 1.07% | 14.3 |
| 10 pph LA-PPO | 1786 | 0.89% | 13.6 |
| 10 pph LA-PPO | 2277 | 0.95% | 20.5 |
| Ave | 1787 | 0.93% | 14.3 |
| SD | 239 | 0.17% | 4.0 |
| 20 pph LA-PPO | 2092 | 0.98% | 14.5 |
| 20 pph LA-PPO | 1734 | 0.90% | 12.8 |
| 20 pph LA-PPO | 1699 | 0.90% | 12.6 |
| 20 pph LA-PPO | 1820 | 0.93% | 14.3 |
| 20 pph LA-PPO | 1921 | 0.76% | 13.0 |
| 20 pph LA-PPO | 1802 | 0.75% | 11.1 |
| Ave | 1845 | 0.87% | 13.0 |
| SD | 143 | 0.09% | 1.2 |
| 30 pph LA-PPO | 1875 | 0.54% | 8.1 |
| 30 pph LA-PPO | 1529 | 0.92% | 11.5 |
| 30 pph LA-PPO | 1680 | 0.40% | 5.7 |
| 30 pph LA-PPO | 1942 | 0.54% | 8.6 |
| 30 pph LA-PPO | 1433 | 0.65% | 6.7 |
| 30 pph LA-PPO | 2029 | 0.50% | 8.0 |
| Ave | 1748 | 0.59% | 8.1 |
| SD | 239 | 0.18% | 2.0 |

TABLE 2

| | MOE | | TS |
|---|---|---|---|
| Sample | (MPa) | EAB | (MPa) |
| PPO | 1762 | 0.80% | 8.9 |
| PPO | 1413 | 0.69% | 8.8 |
| PPO | 1401 | 0.81% | 8.9 |
| PPO | 1895 | 0.46% | 6.2 |
| PPO | 2073 | 0.51% | 5.0 |
| PPO | 1763 | 0.64% | 9.6 |
| PPO | 2029 | 0.50% | 8.0 |
| Ave | 1762 | 0.63% | 7.9 |
| SD | 270 | 0.14% | 1.7 |
| 5 pph sLPH | 1508 | 1.17% | 8.8 |
| 5 pph sLPH | 2014 | 0.78% | 14.5 |
| 5 pph sLPH | 2087 | 1.15% | 19.1 |
| 5 pph sLPH | 1400 | 0.87% | 11.1 |
| Ave | 1752 | 0.99% | 13.4 |
| SD | 348 | 0.20% | 4.5 |
| 10 pph sLPH | 1895 | 1.00% | 13.3 |
| 10 pph sLPH | 1982 | 1.66% | 24.8 |
| 10 pph sLPH | 1932 | 2.10% | 30.2 |
| 10 pph sLPH | 1563 | 0.87% | 10.3 |
| Ave | 1843 | 1.41% | 19.6 |
| SD | 190 | 0.58% | 9.4 |
| 20 pph sLPH | 1751 | 0.88% | 13.3 |
| 20 pph sLPH | 1689 | 0.88% | 8.3 |
| 20 pph sLPH | 1929 | 0.88% | 13.8 |
| 20 pph sLPH | 1677 | 0.64% | 8.2 |
| Ave | 1762 | 0.82% | 10.9 |
| SD | 116 | 0.12% | 3.1 |
| 30 pph sLPH | 1199 | 1.08% | 11.9 |
| 30 pph sLPH | 2282 | 0.65% | 12.9 |
| 30 pph sLPH | 1700 | 0.64% | 6.8 |
| Ave | 1727 | 0.79% | 10.5 |
| SD | 542 | 0.25% | 3.3 |
| 40 pph sLPH | 1197 | 0.47% | 5.7 |
| 40 pph sLPH | 1759 | 0.39% | 6.0 |
| 40 pph sLPH | 1681 | 0.37% | 6.8 |
| Ave | 1546 | 0.41% | 6.2 |
| SD | 304 | 0.06% | 0.6 |

### 5. DSC Testing

A model Q200 differential scanning calorimeter (DSC) manufactured by TA Instruments of New Castle, Del., was used for all testing. Each film was tested by first punching out 3/16″ diameter circles with a total weight of about 6-11 mg. The samples were then stacked in a DSC pan, TA part #901683.901, and closed with a pan lid, TA part #901671.901. The pans were tested using the instrument's standard “heat/cool/heat” method with a starting temperature of 50° C. for each of the two cycles. The heating rates were 20° C./s and the cooling rates were 10° C./s. The maximum temperature for each cycle was chosen to be approximately 15° C. above the expected glass transition temperature in order to preclude any degradation of the polymer. The resultant scans were analyzed using the TA analysis package, and the resultant glass transition temperature was calculated in the standard method from the second heating cycle. Even though this is the standard procedure, the differences between the first and second heating cycle were minimal. The results for films containing 5 parts, 10 parts, 20 parts, 30 parts, and 40 parts lignin propionate hexanoate per 100 parts poly-2,6-dimethyl-1,4-phenylene oxide are summarized in Table 3 below and depicted graphically in FIG. 7.

TABLE 3

| pph LPH | wt % LPH (calc.) | Tg (° C.) |
|---|---|---|
| 0 | 0 | 213.1 |
| 5 | 4.762 | 205.5 |
| 10 | 9.091 | 199.5 |
| 20 | 16.667 | 191.9 |
| 30 | 23.077 | 183.1 |
| 40 | 28.571 | 9.6 |

While illustrative embodiments have been illustrated and described, it will be appreciated that various changes can be made therein without departing from the spirit and scope of the claimed subject matter.

1. A lignin ester extended polyphenylene oxide-based polymer containing from 1 part to about 40 parts lignin ester per 100 parts polyphenylene oxide-based polymer on a weight basis, wherein the ester groups of the lignin ester are represented by the formula: 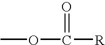
wherein R is a hydrocarbon containing from 1 to 12 carbon atoms.

2. The lignin ester extended polyphenylene oxide-based polymer of claim 1, wherein the polyphenylene oxide-based polymer is poly-2,6-dimethyl-1,4-phenylene oxide.

3. The lignin ester extended polyphenylene oxide-based polymer of claim 1, wherein the lignin ester is fully esterified.

4. The lignin ester extended polyphenylene oxide-based polymer of claim 1, wherein the lignin ester is lignin acetate.

5. The lignin ester extended polyphenylene oxide-based polymer of claim 1, wherein the lignin ester is lignin propionate hexanoate.

6. The lignin ester extended polyphenylene oxide-based polymer of claim 1, wherein the extended polymer contains from 1 part to about 30 parts lignin ester per 100 parts polyphenylene oxide-based polymer.

7. The lignin ester extended polyphenylene oxide-based polymer of claim 6, wherein the extended polymer contains from 5 parts to about 30 parts lignin ester per 100 parts polyphenylene oxide-based polymer.

8. The lignin ester extended polyphenylene oxide-based polymer of claim 1, wherein the extended polymer is characterized by an elongation at break value that is at least 100% of the elongation at break of the unextended polyphenylene oxide-based polymer.

9. The lignin ester extended polyphenylene oxide-based polymer of claim 1, wherein the extended polymer is characterized by a modulus of elasticity value that is at least 100% of the modulus of elasticity of the unextended polyphenylene oxide-based polymer.

10. The lignin ester extended polyphenylene oxide-based polymer of claim 1, wherein the extended polymer is characterized by a tensile strength value that is at least 100% of the tensile strength of the unextended polyphenylene oxide-based polymer.

11. A lignin ester extended polyphenylene oxide-based polymer wherein ester groups of the lignin ester are represented by the formula: 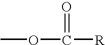
wherein R is a hydrocarbon containing from 1 to 12 carbon atoms wherein the lignin ester is present in an amount effective to result in a extended polymer that exhibits a modulus of elasticity value that is substantially the same as or greater than the modulus of elasticity value of the unextended polyphenylene oxide-based polymer, an elongation at break value that is substantially the same as or greater than the elongation at break value of the unextended polyphenylene oxide-based polymer, and a tensile strength value that is at least 100% of the tensile strength value of the unextended polyphenylene oxide-based polymer.

12. The lignin ester extended polyphenylene oxide-based polymer of claim 11, wherein the lignin ester is lignin acetate.

13. The lignin ester extended polyphenylene oxide-based polymer of claim 11, wherein the lignin ester is lignin propionate hexanoate.

14. The lignin ester extended polyphenylene oxide-based polymer of claim 11, wherein the polyphenylene oxide-based polymer is poly-2,6-dimethyl-1,4-phenylene oxide.
